(19) United States
(12) Patent Application Publication
(10) Pub. No.: US 2023/0252111 A1
(43) Pub. Date: Aug. 10, 2023

(54) CONTENT PROVISION DEVICE, CONTENT PROVISION METHOD, PROGRAM, AND RECORDING MEDIUM

(71) Applicant: FUJIFILM Corporation, Tokyo (JP)

(72) Inventor: Yukinori YOKOYAMA, Saitama-shi (JP)

(73) Assignee: FUJIFILM Corporation, Tokyo (JP)

(21) Appl. No.: 18/066,936

(22) Filed: Dec. 15, 2022

(30) Foreign Application Priority Data
Feb. 8, 2022 (JP) 2022-017616

(51) Int. Cl. G06F 21/10

(52) U.S. Cl. CPC G06F 21/10; G06F 2221/0713

(57) ABSTRACT

A content provision device, a content provision method, a program, and a recording medium capable of opening content, which is provided to a user, to others while protecting the content are realized.

In the present invention, a processor executes a step of providing first content to a first user in a case in which a provision request for the first content is received from the first user, and a step of providing second content lacking a part of data from the first content to the first user in a case in which predetermined processing for the provided first content is executed by a device used by the first user.

### CROSS-REFERENCE TO RELATED APPLICATIONS

The present application claims priority under 35 U.S.C. § 119 to Japanese Patent Application No. 2022-017616, filed on Feb. 8, 2022. The above application is hereby expressly incorporated by reference, in its entirety, into the present application.

### BACKGROUND OF THE INVENTION

### 1. Field of the Invention

The present invention relates to a content provision device, a content provision method, a program, and a recording medium that provide content to a user.

### 2. Description of the Related Art

With the development of communication technology in recent years, a user can obtain desired content through a network from a person (holder) who holds content, such as an image, a video, and audio. The user who has obtained the content can use the content. For example, in a case in which the content is the image, the user can display the image or print the image.

Moreover, the user who has obtained the content may post an article related to the obtained content on a social networking service (SNS) or a blog (weblog) posting site in order to introduce the content to others (for example, JP2021-39512A).

In JP2021-39512A, information related to trial of the content is output to a content purchaser, and the content purchaser posts a post article based on the output information to the SNS. As a result, it is possible to make the purchased content known to more people and to spread and diffuse the content.

### SUMMARY OF THE INVENTION

However, in a case in which the purchased content is open as it is on the SNS or the like, there is a concern that the content is used without permission by a viewer of the SNS or the like and is not appropriately protected. In this case, a right related to the content, such as a portrait right or a copyright, is infringed, and a profit received by the content holder by providing the content is impaired.

The present invention has been made in view of the above circumstances, and is, specifically, to realize a content provision device, a content provision method, a program, and a recording medium capable of opening content, which is provided to a user, to others while protecting the content.

In order to achieve the object described above, an aspect of the present invention relates to a content provision device comprising a processor, in which the processor provides first content to a first user in a case in which a provision request for the first content is received from the first user, and provides second content lacking a part of data from the first content to the first user in a case in which predetermined processing for the provided first content is executed by a device used by the first user.

Moreover, the first content may be a target image, and the predetermined processing may be processing of printing the target image.

Moreover, the second content may be an image in which an image quality of the target image is reduced or an image in which a part of the target image is replaced with another image.

Moreover, the processor may provide the first content to a second user in a case in which derived information including the second content is distributed based on an operation of the first user and a provision request for the first content based on the derived information is received from the second user.

Moreover, the derived information may include code information used for connection to a provision source of the first content. Then, it is suitable that the processor provides the first content to the second user in a case in which the provision request, which is made through the code information in the derived information, is received from the second user.

Moreover, the second content may be content for posting, and the derived information may be information indicating a post article including the second content.

Moreover, the processor may store identification information of the first user corresponding to the derived information referred to by the second user in a storage device, as information related to the second user who has made the provision request based on the derived information.

Moreover, the processor may generate, in a case in which a predetermined number or more of the second users have made the provision request based on the same derived information, information for identifying the first user corresponding to the derived information referred to by the predetermined number or more of the second users, as a target for granting advantage.

Moreover, the processor may store information related to a provision order of the first content in a storage device, as information related to the first user to whom the first content is provided.

Moreover, in order to solve the object described above, another aspect of the present invention relates to a content provision method comprising causing a processor to execute a step of providing first content to a first user in a case in which a provision request for the first content is received from the first user, and a step of providing second content lacking a part of data from the first content to the first user in a case in which predetermined processing for the provided first content is executed by a device used by the first user.

Moreover, in the content provision method described above, the processor may further execute a step of providing the first content to a second user in a case in which derived information including the second content is distributed based on an operation of the first user and a provision request for the first content based on the derived information is received from the second user.

Moreover, in the content provision method described above, the derived information may include code information used for connection to a provision source of the first content. Then, it is suitable that the processor further executes a step of providing the first content to the second user in a case in which the provision request, which is made through the code information in the derived information, is received from the second user.

Moreover, in the content provision method described above, the processor may further execute a step of storing identification information of the first user corresponding to the derived information referred to by the second user in a storage device, as information related to the second user who has made the provision request based on the derived information.

Moreover, in the content provision method described above, the processor may further execute a step of generating, in a case in which a predetermined number or more of the second users have made the provision request based on the same derived information, information for identifying the first user corresponding to the derived information referred to by the predetermined number or more of the second users, as a target for granting advantage.

Moreover, according to still another aspect of the present invention, it is possible to realize a program causing a computer to execute each step included in the content provision method described above. Further, according to still another aspect of the present invention, it is possible to realize a computer-readable recording medium in which a program causing a computer to execute each step included in the content provision method described above is recorded.

According to the aspects of the present invention, the second content lacking a part of data from the first content is provided to the first user by using, as a trigger, the execution of the predetermined processing for the first content provided to the first user. For example, the first user can use the second content in a case of posting the article introducing the first content to the SNS or the like. As a result, the first content can be opened to others while protecting the first content.

### BRIEF DESCRIPTION OF THE DRAWINGS

FIG. 1 is a diagram showing a communication system used for a content provision service.

FIG. 2 is a diagram showing an example of a post article.

FIG. 3 is an explanatory diagram of a target image which is a first content and an image for posting which is a second content.

FIG. 4 is a diagram showing a printed target image.

FIG. 5 is a diagram showing a hardware configuration of each of a content provision device and a user terminal according to one embodiment of the present invention.

FIG. 6 is a diagram showing functions of the content provision device and the user terminal according to one embodiment of the present invention.

FIG. 7 is a diagram showing an example of information stored in a storage device.

FIG. 8 is a diagram showing a content provision flow according to one embodiment of the present invention (part 1).

FIG. 9 is a diagram showing the content provision flow according to one embodiment of the present invention (part 2).

FIG. 10 is a diagram showing a content provision flow according to a modification example of the present invention.

### DESCRIPTION OF THE PREFERRED EMBODIMENTS

A specific embodiment of the present invention will be described with reference to the drawings. It should be noted that the embodiment described below is merely an example for ease of understanding of the present invention, and is not intended to limit the present invention. Moreover, the present invention may be changed or improved from the embodiment described below without departing from the spirit of the present invention. Moreover, the present invention includes its equivalents.

In the present specification, the concept of “device” includes a single device that exerts a specific function in one device, and includes a plurality of devices that are distributed and present independently of each other and exert a specific function in cooperation (coordination) with each other.

Moreover, in the present specification, an “image” is image data unless otherwise specified. Examples of the image data include lossy compressed image data, such as joint photographic experts group (JPEG) format, and lossless compressed image data, such as graphics interchange format (GIF) or portable network graphics (PNG) format.

Moreover, in the present specification, a “user” is a user who uses a content provision device according to the embodiment of the present invention. The use of the content provision device means to use a function of the content provision device, and includes a case in which the function of the content provision device is used by another device (for example, a user terminal) in addition to a case in which the content provision device is directly used.

About Content Provision Service

One embodiment of the present invention (present embodiment) relates to a data processing technology in a content provision service that provides content to the user through a network. That is, the content provision device according to the present embodiment (hereinafter, a content provision device 10) is used for the content provision service.

The user can obtain desired content by using the content provision service. In other words, the content provision device 10 provides the content selected by the user from the content that can be provided by a content holder to the user. Providing the content to the user means distributing data for using the content to a device used by the user.

Examples of the device used by the user include a user terminal 100 and a printer 120, which will be described below, but may include a device that is not owned by the user and can be used by inputting account information and logging in, such as a terminal installed in a store. In a case of providing the content, this device may cause the user to input collation information (order number or the like) transmitted from the content provision device 10 to check a content of the content which is a provision target and the user who has paid a price for the content provision.

Examples of the content that can be provided include an image, an image with audio data, and audio-only data. The image includes a still image and a moving image, and the moving image includes a moving image displayed in a 2D format (normal moving image), a moving image displayed in a 3D format, a moving image displayed in a virtual reality (VR) format, and the like.

In the following, a case will be described in which an image, specifically, an image of a subject having market value (for example, an image of a celebrity, such as an actor or an artist) is provided as the content.

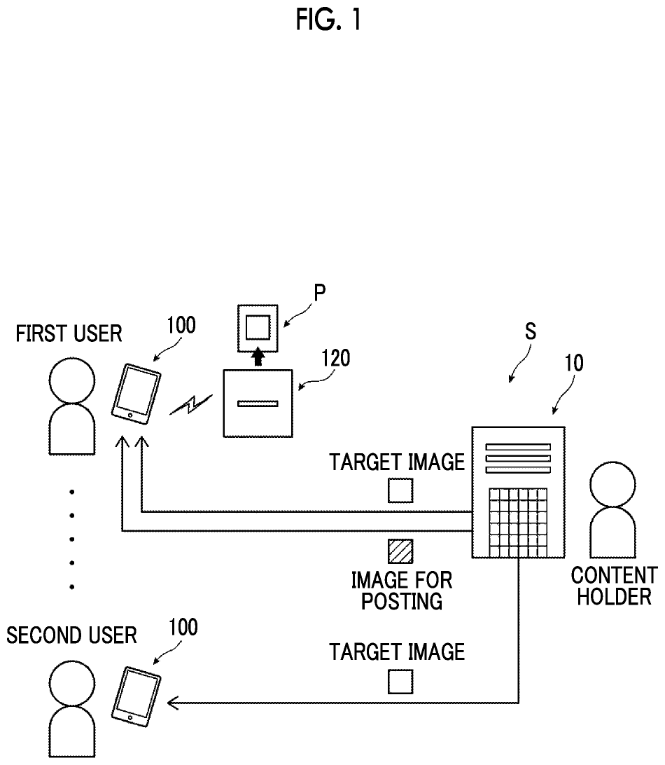

The content provision service will be described with reference to FIG. 1. Any user (hereinafter, referred to as a first user) who uses the service purchases a desired image (hereinafter, referred to as a target image) from among one or two or more images sold by the content holder. Specifically, the first user operates the user terminal 100 to access the homepage of the content holder and performs a purchase procedure of the target image on the homepage.

Here, the target image corresponds to first content that the first user requests the content holder to provide. Moreover, the content holder corresponds to a provision source of the first content.

In a case in which the purchase procedure is performed, a provision request for the target image is transmitted from the user terminal 100 of the first user to the content provision device 10. In a case in which the provision request is received from the first user, the content provision device 10 provides the target image to the first user in response to the request. Specifically, the content provision device 10 transmits the target image to the user terminal 100 of the first user.

Moreover, billing processing for the first user is executed along with the provision of the target image. The content provision device 10 may provide the target image to the first user on a condition that the first user pays a billing amount (price of the target image).

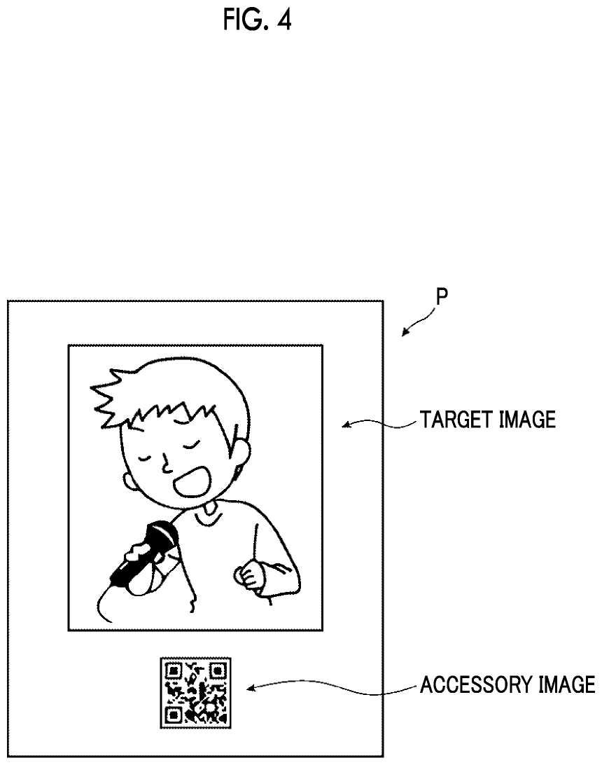

The first user can use the target image provided by the content provision device 10, and can print the target image, for example, as shown in FIG. 1. Specifically, after the user terminal 100 of the first user receives the target image from the content provision device 10, the first user operates the user terminal 100 to instruct to print the target image. The user terminal 100 controls the printer 120 owned by the first user to print the target image. As a result, a film on which the target image is printed (hereinafter, a printed matter P) is obtained (see FIG. 4). It should be noted that the present invention is not limited to this, and the printer 120 may receive the target image from the content provision device 10 and print the target image by using the reception as a trigger.

It should be noted that a print method of the target image is not particularly limited. However, for example, an instant photographic method may be used in which a film having a photosensitive property is exposed to form a latent image and then a developer is developed on a surface of the film to visualize the latent image. Alternatively, a method other than the instant photographic method, for example, an inkjet method, a sublimation-type thermal transfer method, or an electrophotographic method using a toner, may be used.

Moreover, as shown in FIG. 4, an accessory image that can be read by a camera of the user terminal 100 may be printed together with the target image on the printed matter P of the target image. As shown in FIG. 4, the accessory image consists of, for example, a QR code (registered trademark), and is information for causing the user terminal 100 to access predetermined information by being read by the camera of the user terminal 100. The information that can be accessed by reading the accessory image is another content associated with the target image, for example, the audio or the video of the subject in the target image, and is information that can be reproduced by the user terminal 100.

Moreover, the first user may specify a transmission destination (specifically, about several other parties) and transmit the target image as one use aspect of the target image.

Moreover, the first user can post the provided target image to the SNS, a blog posting site, or the like for the purpose of introducing the provided target image. Specifically, the first user activates an application program for posting on the user terminal 100 of the first user, and inputs a post article introducing the target image through an input device of the user terminal 100. It should be noted that the application program for posting may be automatically activated in conjunction with the purchase of the target image or the printing of the target image.

After the first user inputs the article, the user terminal 100 transmits data of the input post article to a posting reception server (not shown). As a result, post information of the first user, that is, information indicating the post article introducing the target image is distributed via the network, and other users can view the post article.

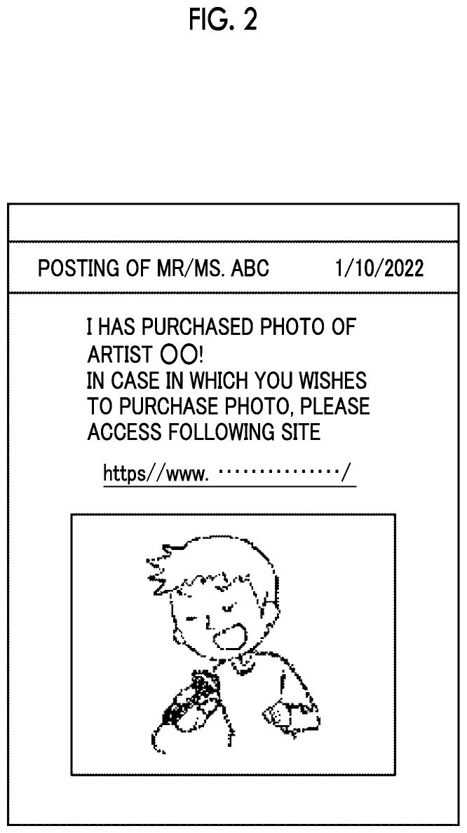

Here, the post information of the first user related to the target image corresponds to derived information derived from the provision of the target image, and is distributed based on an operation of the first user after the provision of the target image. Moreover, as shown in FIG. 2, the post information of the first user includes a unique resource locator (URL) of the provision source of the target image, specifically, the homepage of the content holder who holds the target image. The URL of the homepage of the content holder is code information used for connection (accessing) to the homepage of the content provider. It should be noted that the URL included in the post information may be represented by character information or may be represented by two-dimensional bar code information, such as a QR code (registered trademark).

Moreover, among the users who have viewed the post information of the first user, a person who is interested in the target image introduced by the first user and wishes to purchase the target image (hereinafter, referred to as a second user) may appear. The second user operates the user terminal 100 of the second user to access the homepage of the content holder through the URL included in the post information. In the following, in the same procedure as in a case in which the first user purchases the target image, the second user purchases the target image, and in accordance with this, the provision request for the target image is transmitted from the user terminal 100 of the second user to the content provision device 10. In a case in which the provision request is received from the second user, the content provision device 10 provides the target image to the second user in response to the request.

The second user to whom the target image is provided can use the target image in the same manner as the first user, and for example, can display the target image on the user terminal 100 or print the target image. Moreover, the second user can post the target image to the SNS, the blog posting site, or the like for the purpose of introducing the target image.

As described above, the user to whom the target image is provided (that is, a purchaser of the target image) can post the target image on the SNS or the blog posting site to introduce or promote the target image to spread the target image and expand the market of the target image.

Moreover, the content provision device 10 manages the number of users who have requested the provision of the target image, that is, the number of users who have accessed the homepage of the content holder from the URL included in the post information and have purchased the target image. Then, in a case in which the number of users reaches a set value, the content holder may start the provision (selling) of the content related to the target image, specifically, a new image or the like related to the subject in the target image.

Further, in a case in which a predetermined number or more of the second users have requested the provision of the target image based on the same post information, advantage may be granted to the first user (hereinafter, a target user) who has posted the post information which is referred to by the predetermined number or more of the second users. The advantage may be, for example, money corresponding to a part of the price paid by the second user in purchasing the target image, or may be another content related to the target image.

It should be noted that the target user to whom the advantage is granted need only include the first user who has posted the post information referred to by the predetermined number or more of the second users, and may further include other users related to the first user. Other users related to the first user may include a user who has purchased the target image but has not printed or posted the target image, and a user who has viewed the post information of the first user but has not purchased the target image. Moreover, all the purchasers of the target image may be the target users, or all persons who have viewed the purchase site of the target image (that is, the homepage of the content holder who holds the target image) may be the target users.

By the way, as described above, the first user to whom the target image is provided by the content holder can post the article introducing the target image. In this case, the first user may quote the target image, specifically, may attach the target image to the post information. Here, in a case in which the provided target image is attached to the post information as it is, there is a concern that the target image is used without permission by others who view the post information. Specifically, there may be a case in which an original target image attached to the post information is copied and used without permission.

Therefore, in the present embodiment, an image for posting different from the target image is provided to the first user to whom the target image is provided. The image for posting corresponds to second content, and is, for example, content for posting used in a case in which the first user posts the article introducing the target image. The image for posting is an image obtained by processing the target image, specifically, is an image lacking a part of data from the target image (first content).

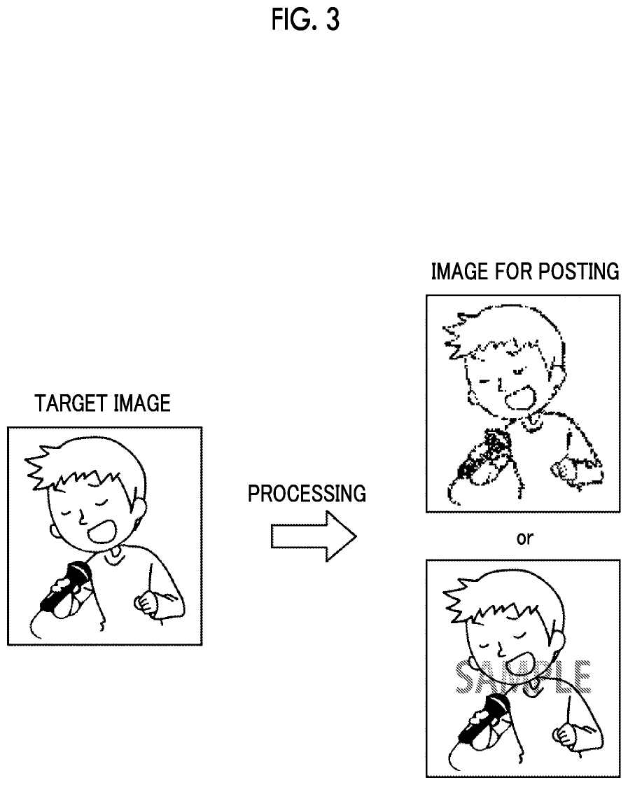

The image lacking a part of data from the target image is an image lacking gradation value data for a part of the pixels constituting the target image. For example, an image in which a part of the target image is replaced with another image (image of a character “SAMPLE” in a lower right figure of FIG. 3) as shown in FIG. 3 may be used as the image for posting. Alternatively, an image in which an image quality of the target image is reduced, specifically, an image in which a resolution is reduced from the original target image as shown in an upper right figure of FIG. 3, or an image obtained by performing shading processing or mosaic processing on the target image may be used as the image for posting.

As described above, by providing the image for posting to the first user and quoting (attaching) the image for posting to the post information of the first user, it is possible to refrain from quoting the original target image. As a result, it is possible to avoid the use of the original target image without permission, and it is possible to widely introduce (promote) the target image to others through posting the target image on the SNS or the blog posting site while protecting the target image.

### Configuration Examples of Content Provision Device and Peripheral Devices Thereof According to Present Embodiment

Next, a configuration example of each of the content provision device 10 and peripheral devices thereof will be described.

The content provision device 10 is composed of a computer, specifically, a server computer (hereinafter, referred to as a server). The server functions as a platform for the content provision service, and is used by, for example, the content holder or a business operator of the content provision service.

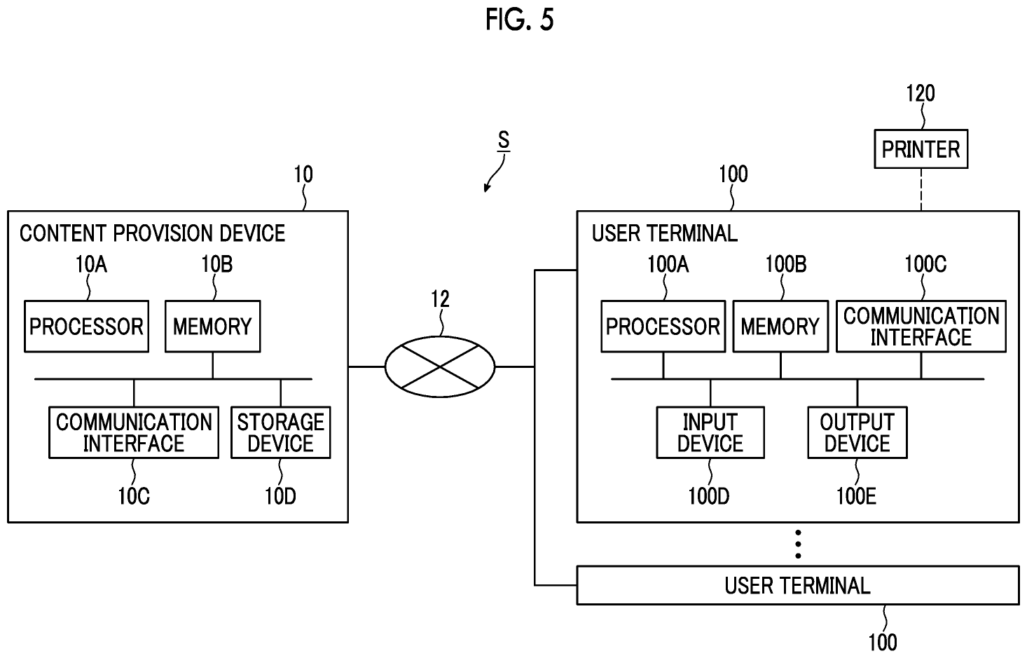

The server has a general-purpose configuration as the server computer for a cloud service, and comprises a processor 10A, a memory 10B, a communication interface 10C, a storage device 10D, and the like, as shown in FIG. 5.

The processor 10A is composed of, for example, a central processing unit (CPU), a graphics processing unit (GPU), a digital signal processor (DSP), or a tensor processing unit (TPU).

The memory 10B is composed of, for example, a semiconductor memory, such as a read only memory (ROM) and a random access memory (RAM).

The communication interface 10C is composed of, for example, a network interface card or a communication interface board.

The storage device 10D is composed of, for example, a storage built in or external to the server. It should be noted that the present invention is not limited to this, and the storage device 10D may be composed of a third computer (for example, an external server) capable of communicating with the server.

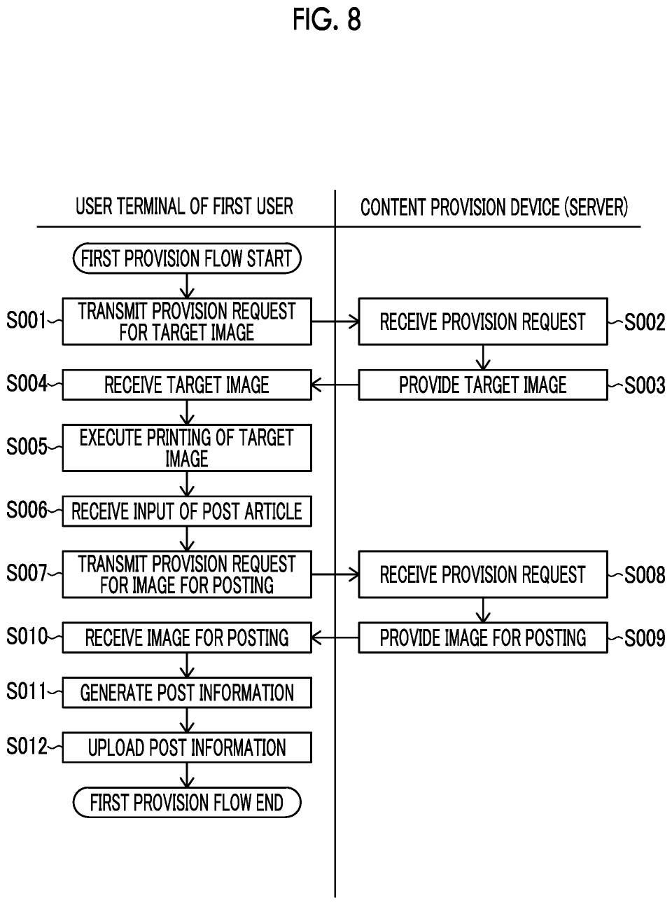

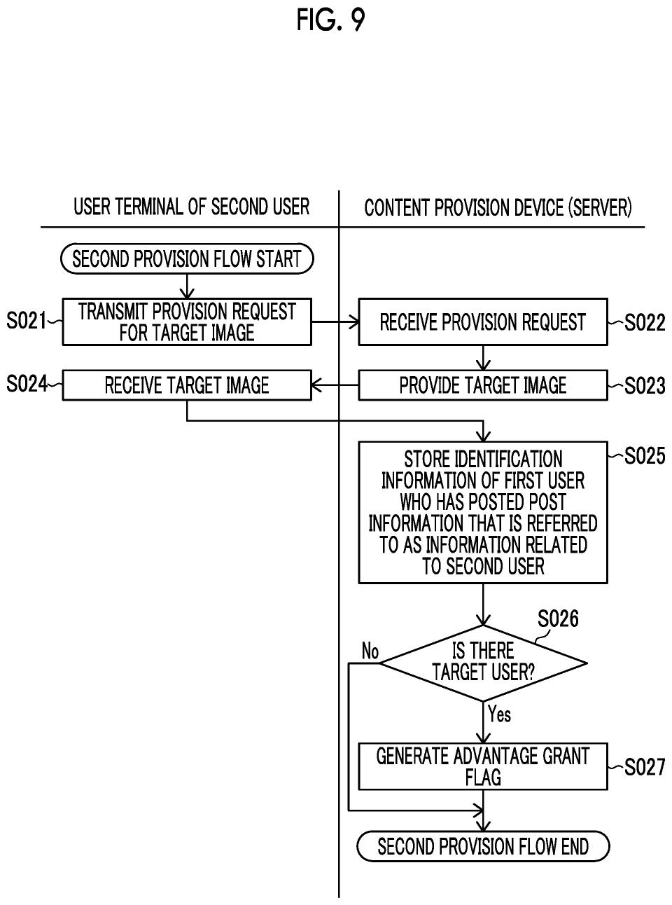

Moreover, a program (hereinafter, a server-side program) for functioning as the content provision device 10 according to the embodiment of the present invention is installed in the server. The server-side program is a program for causing the computer to execute each step (specifically, each step shown in FIGS. 8 and 9) included in a content provision method according to the embodiment of the present invention.

It should be noted that the server-side program may be acquired by being read from a computer-readable recording medium, or may be acquired by being received (downloaded) through a communication line, such as the Internet or an intranet.

The server constituting the content provision device 10 can communicate with the user terminal 100 of the user who uses the content provision service via the communication network 12, and constructs a service system S together with the user terminal 100 (see FIG. 1).

The user terminal 100 consists of a computer used by the user, specifically, is composed of a smartphone, a tablet terminal, a laptop personal computer (PC), or the like. As shown in FIG. 5, the user terminal 100 comprises a processor 100A, a memory 100B, a communication interface 100C, an input device 100D, and an output device 100E. Moreover, various programs (hereinafter, referred to as terminal-side programs) such as the browser, the application program for posting, and a printer driver for controlling the printer 120 are installed in the user terminal 100.

The user terminal 100 has a function of causing the printer 120 to print the target image which is the content obtained through the content provision service. The printer 120 is a portable printer, and prints the target image and the accessory image on the film by the instant photographic method. The printer 120 may be connected to the user terminal 100 by Wi-Fi (registered trademark) or Bluetooth (registered trademark) by a wireless method or may be connected by a wired method.

It should be noted that the printer 120 is not limited to the portable printer described above, and need only be any device used by the user for the purpose of printing the target image. For example, a general home-use printer, a store-installed printer, or a combination machine that can be used in a case in which the user visits the store, or the like may be used as the printer 120.

Next, the configurations of the content provision device 10 composed of the server and the user terminal 100 will be described again from the functional aspect.

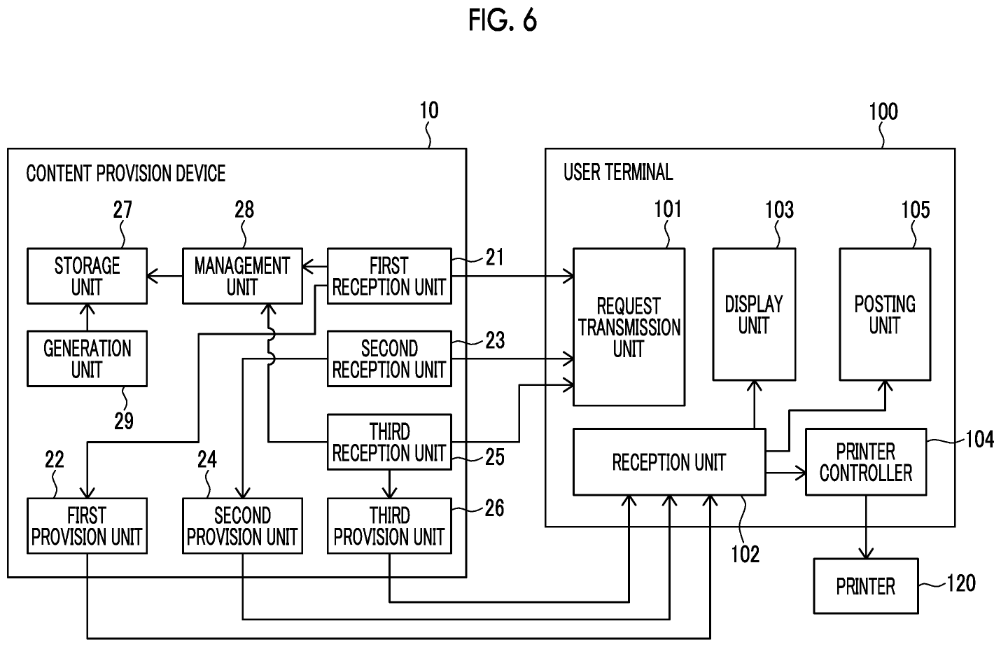

As shown in FIG. 6, the user terminal 100 comprises a request transmission unit 101, a reception unit 102, a display unit 103, a printer controller 104, and a posting unit 105. These functional units are realized by the cooperation between a hardware device provided in the user terminal 100 and the software including the terminal-side program described above.

The request transmission unit 101 specifies the target image, which is the first content selected by the user, based on a request operation by the user, and transmits the provision request (transmission request) of the specified target image to the content provision device 10. It should be noted that the request operation by the user is an operation for purchasing the target image, and includes an operation of selecting an image which is a purchase target from an image group that can be provided by the content holder and an operation of deciding the purchase. These operations are performed, for example, by displaying the homepage of the content holder on a screen of the user terminal 100, specifically, are performed through an input form for image purchase provided in the homepage.

Moreover, in a case in which the first user purchases the target image and executes predetermined processing on the target image, the request transmission unit 101 of the user terminal 100 of the first user transmits the provision request (transmission request) of the image for posting to the content provision device 10. The predetermined processing on the target image is processing executed by a device used by the first user who has purchased the target image, and is, for example, processing for printing the target image.

It should be noted that the predetermined processing on the target image is not limited to the processing described above, and may be processing of posting the article or the like introducing the target image to the SNS or the blog posting site, or processing of requesting the posting to the content holder. Alternatively, processing of purchasing and obtaining the target image, that is, processing of receiving the target image provided by the content provision device 10 may be used. Alternatively, processing in which the first user transmits the target image to a specific transmission destination (for example, a few other parties) may be used.

The reception unit 102 receives the content, such as the image, transmitted from the content provision device 10 through the communication network 12. The content received by the reception unit 102 includes the target image, the accessory image, the content that can be acquired by reading the accessory image, the image for posting, and the like.

The display unit 103 displays various information received by the user terminal 100 on the screen. The information displayed by the display unit 103 includes the content received from the content provision device 10, such as the target image, various websites including the homepage of the content holder, and the post article on the SNS or the blog posting site.

The printer controller 104 controls the printer 120 to print an image which is a print target. For example, after the reception unit 102 receives the target image from the content provision device 10, the user operates the user terminal 100 to request the printing of the target image. In this case, the printer controller 104 generates control data for printing the target image and transmits the control data to the printer 120. In a case in which the control data is received, the printer 120 is operated in accordance with the control data to print the target image (in other words, create the printed matter P).

It should be noted that, in a case in which the reception unit 102 receives the accessory image together with the target image, the printer controller 104 controls the printer 120 to print the target image and the accessory image on the same film (see FIG. 4).

The posting unit 105 transmits, specifically, uploads the post information indicating the article (post article) input by the user operating the user terminal 100 to the posting reception server. For example, in a case in which the user who has purchased the target image, that is, the first user inputs the post article introducing the target image, the posting unit 105 uploads the post information indicating the article. The post information in this case is the derived information related to the target image, and includes the code information used for the connection (accessing) to the provision source of the target image, specifically, the URL of the homepage of the content holder (see FIG. 2).

Moreover, the posting unit 105 uploads the post information including the image for posting received by the reception unit 102 in a case of uploading the post information indicating an introduction article of the target image. The uploaded post information is distributed by the posting reception server and can be viewed by others, specifically, is displayed on the user terminal 100 of other users who use the SNS or the like.

As shown in FIG. 6, the content provision device 10 includes a first reception unit 21, a first provision unit 22, a second reception unit 23, a second provision unit 24, a third reception unit 25, a third provision unit 26, a storage unit 27, a management unit 28, and a generation unit 29. These functional units are realized by the cooperation between a hardware device provided in the content provision device 10 and the software including the server-side program described above.

The first reception unit 21 receives the provision request for the target image from the first user who purchases the target image, specifically, receives information (data) indicating the content of the provision request from the user terminal 100 of the first user. The provision request received by the first reception unit 21 includes identification information of the first user, information for specifying the target image, transmission date and time of the provision request, and the like.

The first provision unit 22 provides the target image to the first user in response to the provision request from the first user, specifically transmits the target image to the user terminal 100 of the first user. Moreover, in a case in which the target image is provided, the first provision unit 22 may provide the accessory image that serves as an access key to the content related to the target image together with the target image. Moreover, the first provision unit 22 may provide information indicating a provision order (that is, a purchase order) of the target image to the first user, specifically, the target image or the accessory image to which a serial number or the like indicating the provision order is attached.

The second reception unit 23 receives the provision request for the image for posting from the first user who has purchased the target image, specifically, receives the information (data) indicating the content of the provision request from the user terminal 100 of the first user. The provision request received by the second reception unit 23 includes the identification information of the first user, the information for specifying the image for posting, the transmission date and time of the provision request, and the like.

The second provision unit 24 provides the image for posting to the first user in response to the provision request from the first user, specifically, transmits the image for posting to the user terminal 100 of the first user. Here, the provision request for the image for posting is transmitted in a case in which the predetermined processing (for example, the print processing of the target image) is executed on the target image by the device used by the first user, as described above. Therefore, the second provision unit 24 provides the image for posting to the first user in a case in which the predetermined processing is executed on the first user side.

It should be noted that the image for posting may be generated by performing the predetermined processing on the target image by the content provision device 10 at a point in time at which the provision request for the image for posting is received from the first user. Alternatively, the image for posting may be generated in advance by the content holder optionally processing the target image.

Moreover, the second provision unit 24 may provide, to the first user, the information indicating the provision order (that is, the purchase order) of the target image to the first user, specifically, the image for posting to which the serial number described above is attached.

In a case in which the second user who has viewed the post information of the first user purchases the target image, the third reception unit 25 receives the provision request for the target image from the second user, specifically, receives the information (data) indicating the content of the provision request from the user terminal 100 of the second user.

The provision request for the target image by the second user is made based on the post information (derived information) of the first user, specifically, is made through the URL in the post information. Specifically, the second user accesses the homepage of the content holder from the URL described above, and performs the purchase procedure of the target image on the homepage. As a result, the provision request for the target image is transmitted from the user terminal 100 of the second user to the content provision device 10. The provision request includes identification information of the second user, the information for specifying the target image, the transmission date and time of the provision request, and the like.

The third provision unit 26 provides the target image to the second user in response to the provision request from the second user, specifically, transmits the target image to the user terminal 100 of the second user. Here, as described above, the provision request for the target image by the second user is made based on the post information of the first user, specifically, is made through the URL in the post information. Therefore, in a case in which the post information is distributed based on the operation of the first user and the provision request for the target image based on the post information is received from the second user, the third provision unit 26 provides the target image to the second user.

It should be noted that a time at which the post information of the first user is distributed and a time at which the provision request of the second user for the target image is received do not always have to be the same time. That is, in the provision of the target image to the second user, the provision request for the target image by the second user may be received at any point in time as long as the point in time is after a point in time at which the post information is distributed.

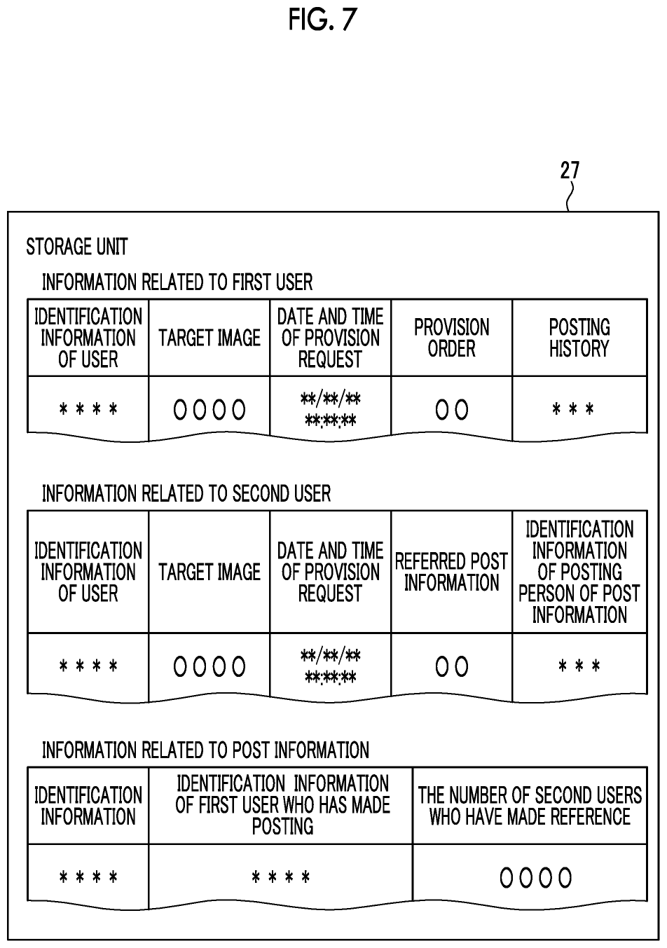

The storage unit 27 is composed of the storage device 10D and stores the information related to the user who uses the content provision service. As shown in FIG. 7, the storage unit 27 stores information related to the first user to whom the target image is provided, information related to the second user who has made the provision request for the target image based on the post information of the first user, and information related to the post information.

The information related to the first user includes, as shown in FIG. 7, the identification information (ID) of the first user, the information of the provided target image, the date and time when the provision request for the target image is made, and information related to the order (provision order) in which the target image is provided. Moreover, the information related to the first user may include information related to a posting history of the article related to the target image.

As shown in FIG. 7, the information related to the second user includes the identification information (ID) of the second user, the target image for which the provision has been requested, and the date and time when the provision request has been made. Moreover, the information related to the second user includes the identification information of the post information referred to in the provision request, and the identification information (ID) of the first user who is a posting person.

The information related to the post information (hereinafter, post-related information) is the information related to the post information introducing the target image. As shown in FIG. 7, the post-related information includes the identification information (ID) of the post information, the identification information (ID) of the first user who has posted the post information, and the number of the second users who have made the provision request for the target image by referring to the post information.

The management unit 28 manages the information to be stored in the storage unit 27, and for example, stores the provision order of the target image in the storage unit 27 as the information related to the first user in a case in which the target image is provided to the first user.

Moreover, in a case in which the second user has made the provision request for the target image based on the post information, the management unit 28 stores the identification information of the referred post information and the identification information of the first user who is the posting person in the storage unit 27, as the information related to the second user. Further, the management unit 28 updates the number of the second users who have referred to the post information as the post-related information that is related to the referred post information.

The generation unit 29 generates an advantage grant flag in a case in which the predetermined number or more of the second users has made the provision request for the target image based on the same post information. The advantage grant flag is information for identifying the first user who has posted the post information referred to by the predetermined number or more of the second users, that is, the target user, as a target of advantage granting. In a case in which the advantage grant flag is generated, for example, the content holder specifies the target user from the advantage grant flag and grants predetermined advantage to the specified target user.

### Content Provision Flow According to Present Embodiment

An information processing flow (hereinafter, a content provision flow) using the content provision device according to the present embodiment will be described. In the content provision flow, the content provision method according to the embodiment of the present invention is adopted. In other words, each step in the content provision flow corresponds to a component of the content provision method according to the embodiment of the present invention.

The content provision flow is divided into a flow shown in FIG. 8 (hereinafter, a first provision flow) and a flow shown in FIG. 9 (hereinafter, a second provision flow). Each step in the first provision flow and the second provision flow is executed by the computer, specifically, the processors 10A and 100A of the server and the user terminal 100 that configure the content provision device 10.

In the following, each flow will be described individually.

First Provision Flow

The first provision flow is a flow in a case in which the first user purchases the target image as the first content, and is started from the transmission of the provision request for the target image by the user terminal 100 of the first user (S001). Specifically, the first user operates the user terminal 100 to perform the purchase procedure of the target image. Moreover, along with the purchase of the target image, the first user performs a settlement procedure for paying the billing amount (price of the target image). In step S001, the provision request corresponding to the content of these procedures is transmitted from the user terminal 100 of the first user.

Next, the server receives the provision request from the first user and provides the target image to the first user in response to the request (S002, S003). In this case, the server may store the provision order of the target image (that is, the order in which the first user has purchased the target image) in the storage device 10D as the information related to the first user.

The user terminal 100 of the first user receives the target image provided from the server (S004). The received target image is displayed on the user terminal 100 of the first user. In this case, the user terminal 100 inquires the first user whether or not to print the received target image. Here, the first user requests the printing of the target image. The user terminal 100 controls the printer 120 to execute the printing of the target image by the printer 120 (S005).

Moreover, the user terminal 100 of the first user activates the application program for posting in conjunction with the reception of the target image, and receives the input of the introduction article (post article) of the target image by the first user (S006).

Thereafter, the user terminal 100 of the first user transmits the provision request for the image for posting (S007). This step S007 may be executed by using, as a trigger, the printing of the target image in step S005, or may be executed by using, as a trigger, the reception of the article input in step S006.

In a case in which the provision request for the image for posting is received from the first user, the server provides the image for posting to the first user in response to the request (S008, S009). The user terminal 100 of the first user receives the image for posting provided from the server (S010). Thereafter, the user terminal 100 generates the post information and uploads the generated post information to the posting reception server (S011, S012). The generated post information includes the image for posting received in step S010, the post article input by the first user, and the URL (code information) of the homepage of the content holder who is the provision source of the target image.

Then, the post information of the first user is uploaded to the posting reception server, so that the post information can be distributed to others through the SNS, the blog posting site, or the like.

At a point in time at which the series of steps up to the above ends, the first provision flow ends. Then, each time a new user purchases the target image (it should be noted that, excluding the purchase of the target image based on the post information), the first provision flow is repeatedly executed.

Second Provision Flow

The second provision flow is a flow in which the second user who has viewed the post information of the first user purchases the target image, and is started from the transmission of the provision request for the target image by the user terminal 100 of the second user (S021). Specifically, the second user accesses the homepage of the content holder from the URL in the viewed post information, and performs the purchase procedure of the target image and the settlement procedure along with the purchase procedure on the homepage. In step S021, the provision request for the target image based on the post information is transmitted from the user terminal 100 of the second user in accordance with the content of these procedures.

Next, the server that configures the content provision device 10 receives the provision request from the second user and provides the target image to the second user in response to the request (S022, S023). That is, in a case in which the post information including the image for posting is distributed based on the operation of the first user and the provision request for the target image based on the post information is received from the second user, the server provides the target image to the second user.

The user terminal 100 of the second user receives the target image provided from the server (S024). As a result, the second user can use the purchased target image, that is, can use an original image of the target image (image for posting) lacking a part of the data in a case of viewing the post information.

Moreover, in a case in which the server receives the provision request from the second user in step S022, the server stores the information related to the second user in the storage device 10D (S024). Specifically, the identification information of the first user who has posted the post information referred to by the second user is stored as the information related to the second user.

Thereafter, the server determines whether or not there is the first user, that is, the target user, who has posted the post information referred to by the predetermined number or more of the second users, based on the information stored in step S024 (S026). Then, in a case in which the server determines that the target user is present, the server generates the advantage grant flag (S027). In a case in which the advantage grant flag is generated, the content holder specifies the target user from the advantage grant flag and grants the predetermined advantage to the specified target user.

At a point in time at which the series of steps up to the above ends, the second provision flow ends. Then, each time a new second user views the post information of the first user and purchases the target image, the second provision flow is repeatedly executed.

### Content Provision Flow According to Modification Example

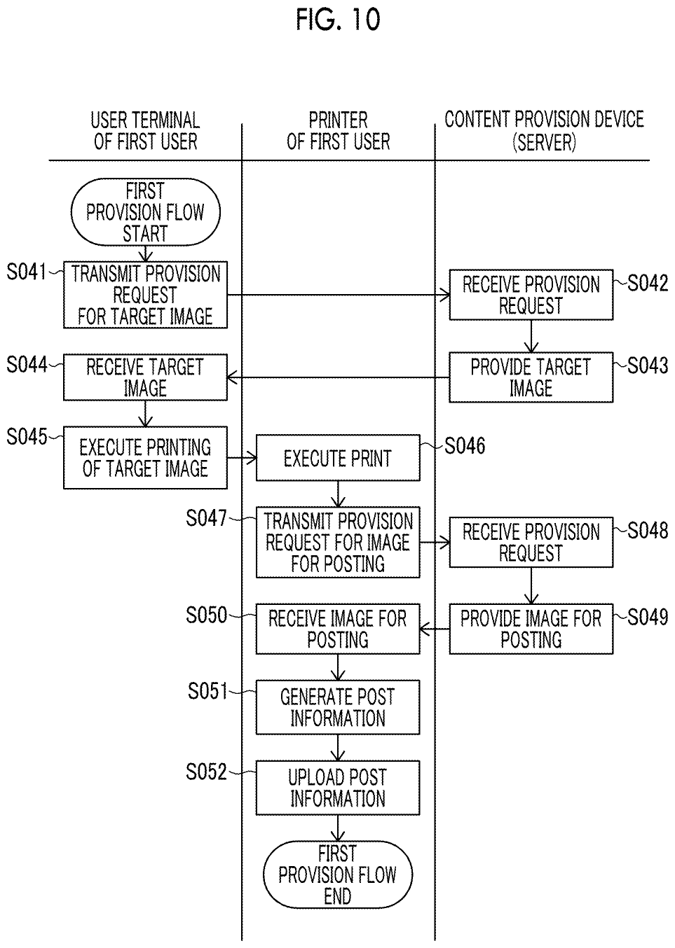

In the embodiment described above, the provision request for the image for posting is transmitted from the user terminal 100 of the first user. It should be noted that the provision request for the image for posting may be transmitted from the printer 120 that can be used by the first user, instead of the user terminal 100. This case is regarded as one modification example of the present invention, and a content provision flow according to the modification example (specifically, a first provision flow according to the modification example) will be described with reference to FIG. 10.

In the first provision flow according to the modification example, the series of steps S041 to S045 from the provision request for the target image to the execution of the printing of the target image are the same as steps S001 to S005 in the first provision flow described above. It should be noted that, in the flow shown in FIG. 10, the target image provided from the server is received by the user terminal 100 of the first user. However, the present invention is not limited to this, and the target image may be directly received by the printer 120.

In the modification example, the printer 120 that can be used by the first user transmits the provision request for the image for posting in a case in which the target image is printed under the control of the user terminal 100 of the first user (S046, S047). This step S047 may be executed by using, as a trigger, the completion of the printing of the target image, or may be executed by using, as a trigger, the first user starting the operation for posting the article (for example, the operation for activating the application program for posting).

In a case in which the provision request for the image for posting is received from the printer 120, the server provides the image for posting in response to the request (S048, S049). The printer 120 of the first user receives the image for posting provided from the server (S050).

Then, in the modification example, the printer 120 that has received the image for posting generates the post information and uploads the generated post information to the posting reception server (S051, S052). Specifically, the printer 120 generates the post information including a fixed-form post article (message), the received image for posting, and the URL of the homepage of the content holder who is the provision source of the target image.

It should be noted that the fixed-form post article may be stored in the printer 120 in advance. Alternatively, an account for posting of the first user may be stored in the printer 120 in advance, and the post information to which the account is attached may be uploaded by the printer 120. In this case, a fixed-form message corresponding to the account described above may be automatically embedded in the post information on the posting reception server side.

### Other Embodiments

The embodiment described above is a specific example given to describe the content provision device and the content provision method according to the embodiment of the present invention in an easy-to-understand manner and is merely an example, and other embodiments can be considered.

In the embodiment described above, the first content for which the first user makes the purchase (provision request) is the image (target image). Then, the second content, which has been processed for posting and lacks a part of data from the first content, is the image in which a part of the target image is replaced with another image, or the image in which the image quality of the target image is reduced. It should be noted that the first content may be content other than the image, for example, the video or the audio data. The second content in this case may be, for example, the video or audio data of a digest version obtained by extracting a part of the video or the audio data. Moreover, in a case in which the first content is the video, the second content may be a frame image (still image) obtained by extracting a part of the video.

Moreover, in the embodiment described above, the printing of the target image provided by the content provision device 10 is executed, and the provision request for the image for posting is made by using the printing as a trigger. It should be noted that the printing of the target image does not always have to be executed. In that case, the provision request for the image for posting may be made by using the purchase of the target image, the input of the article (post article) introducing the target image, or the like as a trigger.

Moreover, in the embodiment described above, the function of the content provision device according to the embodiment of the present invention is exerted by the processor 10A provided in the server, but the present invention is not limited to this. The processor 10A provided in the content provision device according to the embodiment of the present invention may be provided in the device used by the user, for example, the user terminal 100 or the printer 120. That is, a part or all of the functional units provided in the content provision device according to the embodiment of the present invention may be realized by the user terminal 100 or the printer 120.

The processor provided in the content provision device according to the embodiment of the present invention includes various processors. Examples of the various processors include a CPU, which is a general-purpose processor that executes software (program) and functions as various processing units.

Moreover, various processors include a programmable logic device (PLD), which is a processor of which a circuit configuration can be changed after manufacturing, such as a field programmable gate array (FPGA).

Moreover, the various processors described above also include a dedicated electric circuit, which is a processor having a circuit configuration specially designed for executing specific processing, such as an application specific integrated circuit (ASIC).

Moreover, one processing unit provided in the content provision device according to the embodiment of the present invention may be composed of one of the various processors described above, or may be composed of a combination of two or more processors of the same type or different types, for example, a combination of a plurality of FPGAs or a combination of the FPGA and the CPU.

Moreover, a plurality of functional units provided in the content provision device according to the embodiment of the present invention may be composed of one of various processors, or may be composed of one processor in which two or more of the plurality of functional units are combined.

Moreover, as in the embodiment described above, a form may be adopted in which one processor is composed of a combination of one or more CPUs and software, and the processor functions as the plurality of functional units.

Moreover, for example, as represented by a system on chip (SoC) or the like, a form may be adopted in which a processor is used in which the functions of the entire system which includes the plurality of functional units in the content provision device according to the embodiment of the present invention are realized by a single integrated circuit (IC) chip. Moreover, a hardware configuration of the various processors described above may be an electric circuit (circuitry) in which circuit elements, such as semiconductor elements, are combined.

### EXPLANATION OF REFERENCES

10: content provision device
10A: processor
10B: memory
10C: communication interface
10D: storage device
12: communication network
21: first reception unit
22: first provision unit
23: second reception unit
24: second provision unit
25: third reception unit
26: third provision unit
27: storage unit
28: management unit
29: generation unit
100: user terminal
100A: processor
100B: memory
100C: communication interface
100D: input device
100E: output device
101: request transmission unit
102: reception unit
103: display unit
104: printer controller
105: posting unit
120: printer
P: printed matter
S: service system

What is claimed is:

1. A content provision device comprising:
a processor,
wherein the processor
provides first content to a first user in a case in which a provision request for the first content is received from the first user, and
provides second content lacking a part of data from the first content to the first user in a case in which predetermined processing for the provided first content is executed by a device used by the first user.

2. The content provision device according to claim 1,
wherein the first content is a target image, and
the predetermined processing is processing of printing the target image.

3. The content provision device according to claim 2,
wherein the second content is an image in which an image quality of the target image is reduced or an image in which a part of the target image is replaced with another image.

4. The content provision device according to claim 1,
wherein the processor provides the first content to a second user in a case in which derived information including the second content is distributed based on an operation of the first user and a provision request for the first content based on the derived information is received from the second user.

5. The content provision device according to claim 4,
wherein the derived information includes code information used for connection to a provision source of the first content, and
the processor provides the first content to the second user in a case in which the provision request, which is made through the code information in the derived information, is received from the second user.

6. The content provision device according to claim 4,
wherein the second content is content for posting, and
the derived information is information indicating a post article including the second content.

7. The content provision device according to claim 4,
wherein the processor stores identification information of the first user corresponding to the derived information referred to by the second user in a storage device, as information related to the second user who has made the provision request based on the derived information.

8. The content provision device according to claim 7,
wherein the processor generates, in a case in which a predetermined number or more of the second users have made the provision request based on the same derived information, information for identifying the first user corresponding to the derived information referred to by the predetermined number or more of the second users, as a target for granting advantage.

9. The content provision device according to claim 1,
wherein the processor stores information related to a provision order of the first content in a storage device, as information related to the first user to whom the first content is provided.

10. A content provision method comprising:
causing a processor to execute
a step of providing first content to a first user in a case in which a provision request for the first content is received from the first user, and
a step of providing second content lacking a part of data from the first content to the first user in a case in which predetermined processing for the provided first content is executed by a device used by the first user.

11. The content provision method according to claim 10,
wherein the processor further executes a step of providing the first content to a second user in a case in which derived information including the second content is distributed based on an operation of the first user and a provision request for the first content based on the derived information is received from the second user.

12. The content provision method according to claim 11,
wherein the derived information includes code information used for connection to a provision source of the first content, and
the processor further executes a step of providing the first content to the second user in a case in which the provision request, which is made through the code information in the derived information, is received from the second user.

13. The content provision method according to claim 11,
wherein the processor further executes a step of storing identification information of the first user corresponding to the derived information referred to by the second user in a storage device, as information related to the second user who has made the provision request based on the derived information.

14. The content provision method according to claim 13,
wherein the processor further executes a step of generating, in a case in which a predetermined number or more of the second users have made the provision request based on the same derived information, information for identifying the first user corresponding to the derived information referred to by the predetermined number or more of the second users, as a target for granting advantage.

15. A computer-readable recording medium in which a program causing a computer to execute each step included in the content provision method according to claim 10 is recorded.

16. A computer-readable recording medium in which a program causing a computer to execute each step included in the content provision method according to claim 11 is recorded.

17. A computer-readable recording medium in which a program causing a computer to execute each step included in the content provision method according to claim 12 is recorded.

18. A computer-readable recording medium in which a program causing a computer to execute each step included in the content provision method according to claim 13 is recorded.

19. A computer-readable recording medium in which a program causing a computer to execute each step included in the content provision method according to claim 14 is recorded.
